(19) United States
(12) Patent Application Publication
(10) Pub. No.: US 2018/0219361 A1
(43) Pub. Date: Aug. 2, 2018

(54) GUY GUARD WITH REFLECTIVE MATERIAL AND METHOD OF MAKING SAME

(71) Applicants: Robert T. Ritchie, Caledon East (CA); John Robert Davies, Markham (CA)

(72) Inventors: Robert T. Ritchie, Caledon East (CA); John Robert Davies, Markham (CA)

(21) Appl. No.: 15/877,590

(22) Filed: Jan. 23, 2018

Related U.S. Application Data
(60) Provisional application No. 62/449,375, filed on Jan. 23, 2017.

(51) Int. Cl. H02G 3/04; B29C 47/00; B29C 47/06

(52) U.S. Cl. CPC H02G 3/0481; B29C 47/0004; E04H 12/20; B29C 47/064; B29C 47/0023

(57) ABSTRACT

The apparatus has a tube having an exterior tube surface, the exterior tube surface defining one or more grooves. The apparatus further has a portion occupying each of the one or more grooves and integrally formed with the tube. The portion is adapted to reflect light in the visible spectrum. The tube and the portion together define a guy guard. A method and system for forming the apparatus are also disclosed.

### CROSS-REFERENCE TO RELATED APPLICATIONS

The present application claims priority to and all the benefits of U.S. Provisional Application No. 62/449,375, filed on Jan. 23, 2017, which is hereby expressly incorporated herein by reference in its entirety.

### BACKGROUND OF THE INVENTION

### 1. Field of the Invention

The invention relates to the field of guy guards, and more particularly, to guy guards with reflective material.

### 2. Description of the Related Art

It is well known to provide a guy wire with a guard. The purpose of the guard is to make the guy wire highly visible, so as to reduce the potential that passers-by will collide with the guy wire, and to reduce the severity of injuries flowing from collisions that do occur. To serve this purpose, a guard is often constructed out of highly-visible plastic and takes the form of a tube of sufficient length to wrap around that portion of the guy wire that is likely to be the subject of a collision.

In order to make the guy wire more visible in low light or at night, reflective tape is sometimes applied along the guy guard tube. Applying the reflective tape to the guy guard often requires a flame treatment of the polypropylene tube prior to the application of the reflective tape. This flame treatment helps create a chemical bond on the polypropylene surface for the adhesion of inks and paint. The tube parts are rapidly passed through an oxidizing gas/air flame at the corona (i.e. the point where the dark blue and light blue of the flame meet). This forms carbonyl groups on the polypropylene surface and reduces surface tension to allow for wetting and adhesion of inks and paint. The exposed carbonyl begins to oxidize within a short period of time, however, therefore application of the reflective tape must be completed quickly. It is understood by those skilled in the art that contact time of the polypropylene tube with the flame is of extreme importance and is a delicate procedure. If contact time is too short, the chemical reaction does not take place. If too long, surface of the polypropylene begins to melt, making the tube part useless.

Despite the reasonable effectiveness of the above-described application, the reflective tape tends to eventually separate from the tube over time.

### SUMMARY OF THE INVENTION

Forming one aspect of the invention is an apparatus comprising a tube having an exterior tube surface, the exterior tube surface defining one or more grooves, and a portion occupying each of the one or more grooves and integrally formed with the tube, the portion adapted to reflect light in the visible spectrum, where the tube and the portion together defining a guy guard.

According to another aspect, a method of forming a guy guard is provided, the method comprising forming a tube of molten plastic, introducing to the tube of molten plastic a material, which when cooled is reflective to visible light, to extrude a composite product having the same cross section as the tube, the molten material being introduced such that a groove is defined in the tube and the molten material occupies the groove, and cooling the tube and the molten material to form a guy guard having a reflective strip.

Forming another aspect of the invention is a system for forming a reflective guy guard, the system comprising a dual extrusion die and a cooling system. The dual extrusion die having a tube die for forming a molten tube, the tube die having a tube inlet fluidly connected to a source of molten polyethylene, an annular aperture in fluid communication with the tube inlet and terminating at a tube outlet. The dual extrusion die further having a reflective die for extruding a portion, the reflective die operatively coupled to the tube die, the reflective die having a reflective inlet, fluidly connected to a source of molten reflective polyethylene, and an injection channel in fluid communication with the reflective inlet, the injection channel disposed downstream of the tube outlet and adapted to inject molten reflective polyethylene onto the molten tube. The cooling system is operatively coupled downstream of the reflective die adapted to receive the molten tube and the injected portion for cooling.

Further advantages, features and characteristics of the invention will become apparent upon a review of the following detailed description and the appended drawings, the latter being briefly described hereinafter.

### BRIEF DESCRIPTION OF THE DRAWINGS

FIG. 1 is a side perspective view of the apparatus according to an exemplary embodiment of the invention;

FIG. 2 is a cross-sectional view of the apparatus of FIG. 1 along line A-A; and

FIG. 3 is a schematic view of a system for forming the apparatus of FIG. 2 along line B-B.

### DETAILED DESCRIPTION OF THE INVENTION

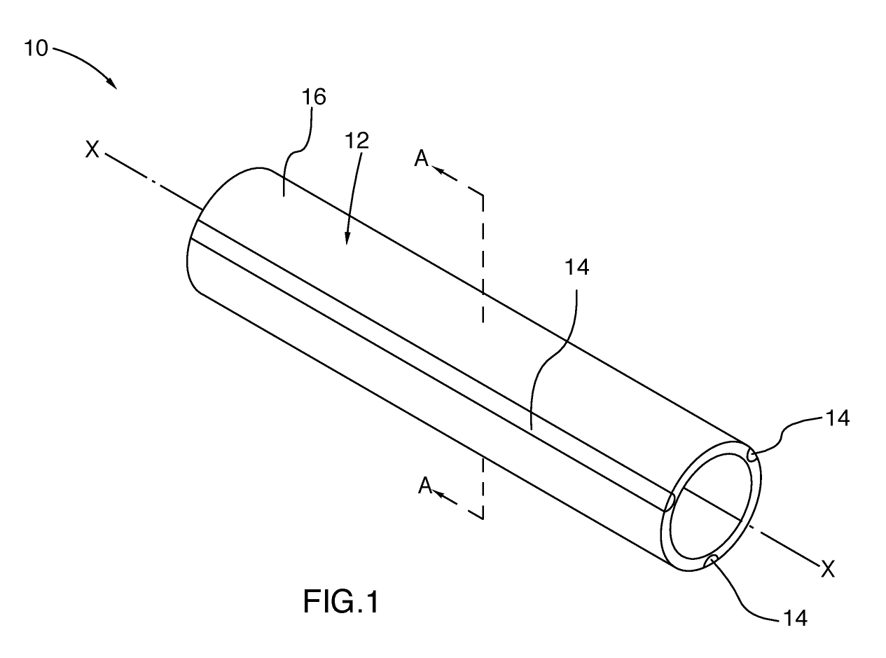

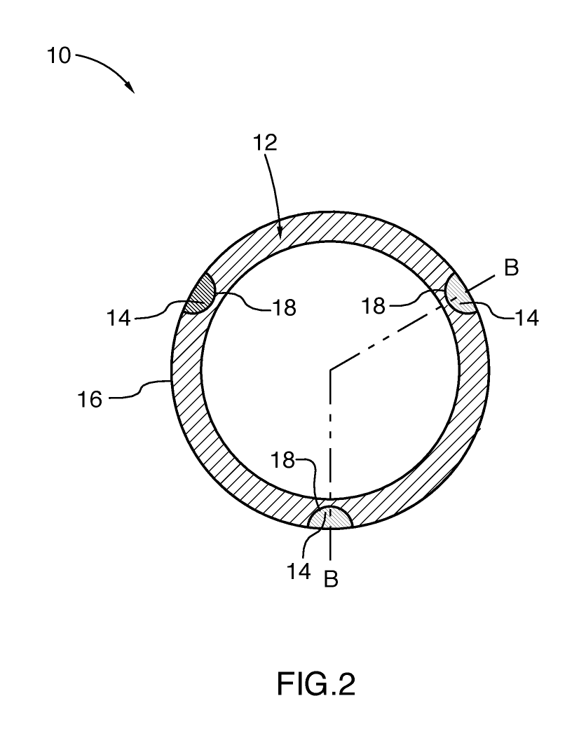

Reference is now made to FIGS. 1 and 2 which show an apparatus 10 according to an exemplary embodiment of the present invention. Apparatus 10 comprises a tube 12 and portions 14, which together define a guy guard.

Tube 12 is formed from medium-density polyethylene and has a longitudinal axis X and an exterior tube surface 16. Exterior tube surface 16 defines three grooves 18 parallel with axis X and equilaterally spaced from one another.

Portions 14 occupy each of grooves 18 and are integrally formed with tube 12. Portions 14 are adapted to reflect light in the visible spectrum. In the depicted embodiment, portions 14 span the length of tube 12. As best seen in FIG. 2, grooves 16 and their corresponding portions 14 are circumferentially and equilaterally spaced around exterior tube surface 16. Similar to tube 12, portions 14 are also formed from polyethylene. This polyethylene is adapted to reflect light by the inclusion of barium titanate glass microspheres (not shown). In order for the barium titanate glass microspheres to be embedded in the polyethylene, the barium titanate glass microspheres are partially coated with aluminum.

In use, apparatus 10 is wrapped around a guy wire or utility pole to make the guy wire or utility pole more visible and to help to prevent injury to passing people or vehicles.

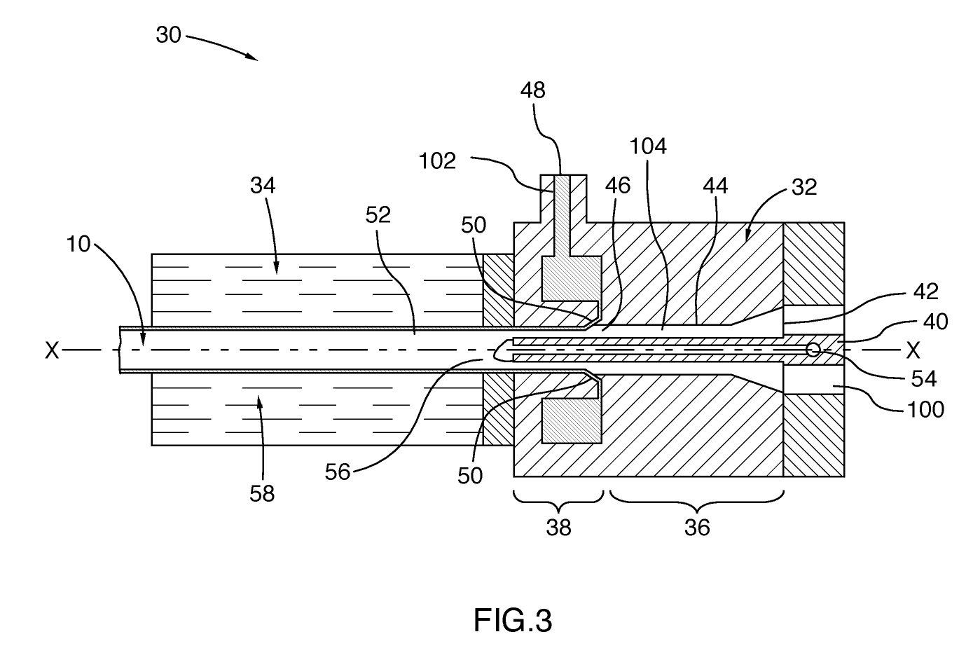

FIG. 3 is a schematic view of a system 30 for forming the apparatus of FIGS. 1 and 2. System 30 comprises a dual extrusion die 32 operatively coupled to a cooling system 34. Dual extrusion die 32 comprises a tube die 36, a reflective die 38 and a mandrel 40.

Tube die 36 comprises a tube inlet 42, fluidly connected to a source (not shown) of molten medium-density polyethylene 100, and an annular aperture 44 in fluid communication with tube inlet 42. Tube die 36 further comprises a tube outlet 46.

Reflective die 38 is operatively coupled to tube die 36 and has a reflective inlet 48, fluidly connected to a source (not shown) of molten reflective polyethylene 102, and injection channels 50 each in fluid communication with reflective inlet 48. Injection channels 50 are disposed downstream of, and coterminous with, tube outlet 46. Injection channels 50 are further positioned at an angle of 15 to 20 degrees from a longitudinal axis X of annular aperture 44. Annular aperture 44 extends through tube die 36 and reflective die 38, terminating at an extrusion outlet 52.

Mandrel 40 is disposed within annual aperture 44 and has a vent 54 for controlling the temperature of mandrel 40.

Cooling system 34 is operatively coupled to, downstream of, reflective die 38. Cooling system 34 comprises an extrusion inlet 56 and a cooling fluid 58.

In use, molten medium-density polyethylene 100 is introduced into annular aperture 44 of tube die 36 through tube inlet 42. Annular aperture 44 and mandrel 40 together form the molten medium-density polyethylene into a molten tube 104, which exits tube die 36 through tube outlet 46. As molten tube 104 moves through annular aperture 44 into reflective die 38, injection channels 50 force or inject molten reflective polyethylene 102 onto molten tube 104 at an angle of 15 to 20 degrees from longitudinal axis X of annular aperture 44. Injecting molten reflective polyethylene 102 onto molten tube 104 in this way adheres molten reflective polyethylene 102 onto molten tube 104, thereby forming a molten extrusion 106.

Molten extrusion 106 then exits annular aperture 46 and passes into cooling system 34. There, molten extrusion 106 is passed through cooling fluid 58, which could be either a water bath or simply cool air. After molten extrusion 106 is cooled, it may be cut along the length of tube 12, parallel to longitudinally axis X, forming apparatus 10.

Without intending to be bound by theory, it is believed that the present invention provides a number of advantages. One advantage of the present invention is that use of the present apparatus negates the need to apply reflective tape onto polyethylene tubes when forming guy guards, thereby negating the need for reflective tape entirely.

Another advantage is that the resulting apparatus maintains the simple construction and easy installation of conventional guy guards while still providing effective amount of light reflection.

A further advantage of the present invention is that the reflection portion of the apparatus will not separate from the tube despite extended use.

Whereas a specific embodiment is shown and described, it will be understood that variations are possible.

For example, whereas barium titanate glass microspheres are described as being included in the molten reflective polyethylene, it will be appreciated that the invention can be used with any material that can be extruded through a die and that reflects visible light.

As well, whereas three reflective stripes are shown on the apparatus, it will be appreciate that variations of the portion in shape, dimension and coverage are possible.

Further, whereas the shape of the injection channel is shown to be cylindrical, it will be appreciate that the shape of the injection channel may be of a different shape, for example, rectangular.

Additionally, whereas a particular dual extrusion die assembly system is shown, it will be appreciated that variations are possible.

Accordingly, the invention should be understood to be limited only by the accompanying claims, purposively construed.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

1. An apparatus comprising:
a tube having an exterior tube surface, the exterior tube surface defining one or more grooves; and
a portion occupying each of the one or more grooves and integrally formed with the tube, the portion adapted to reflect light in the visible spectrum,
the tube and the portion together defining a guy guard.

2. The apparatus as set forth in claim 1, wherein the tube has a central, longitudinal axis defining a length of the tube, the portion forming a reflective strip spanning the length of the tube, parallel to the longitudinal axis.

3. The apparatus as set forth in claim 2, wherein the one or more grooves are multiple grooves, the multiple grooves being circumferentially spaced around the exterior tube surface.

4. The apparatus as set forth in claim 1, wherein the tube comprises medium-density polyethylene and the portion comprises polyethylene.

5. The apparatus as set forth in claim 4, wherein the portion is adapted to reflect light by the inclusion of microspheres comprising barium titanate glass.

6. The apparatus as set forth in claim 5, wherein the microspheres are at least partially coated with aluminum.

7. A method comprising:
forming a tube of molten plastic;
introducing to the tube of molten plastic a material, which when cooled is reflective to visible light, to extrude a composite product having the same cross section as the tube, the molten material being introduced such that a groove is defined in the tube and the molten material occupies the groove; and
cooling the tube and the molten material to form a guy guard having a reflective strip.

8. The method of claim 7, wherein the molten tube has a longitudinal axis and the molten material is introduced onto the molten tube at an angle of 15-20 degrees relative to the longitudinal axis of the molten tube.

9. A system for forming an apparatus, the system comprising:
a dual extrusion die, the dual extrusion die having:
a tube die for forming a molten tube, the tube die having a tube inlet fluidly connected to a source of molten polyethylene, an annular aperture in fluid communication with the tube inlet and terminating at a tube outlet; and
a reflective die for extruding a portion, the reflective die operatively coupled to the tube die, the reflective die having a reflective inlet, fluidly connected to a source of molten reflective polyethylene, and an injection channel in fluid communication with the reflective inlet, the injection channel disposed downstream of the tube outlet and adapted to inject molten reflective polyethylene onto the molten tube; and
a cooling system operatively coupled downstream of the reflective die adapted to receive the molten tube and the injected portion for cooling.

10. The system of claim 9, wherein the molten tube has a longitudinal axis and the injection channel is disposed at an angle of 15-20 degrees relative to the longitudinal axis of the molten tube.
